(19) United States
(12) Patent Application Publication
(10) Pub. No.: US 2025/0155538 A1
(43) Pub. Date: May 15, 2025

(54) RADIO WAVE ARRIVAL DIRECTION ESTIMATION DEVICE AND RADIO WAVE ARRIVAL DIRECTION ESTIMATION METHOD

(71) Applicant: NIPPON TELEGRAPH AND TELEPHONE CORPORATION, Tokyo (JP)

(72) Inventors: Masafumi YOSHIOKA, Musashino-shi, Tokyo (JP); Fumiaki NAGASE, Musashino-shi, Tokyo (JP); Keita KURIYAMA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/839,456

(22) PCT Filed: Feb. 24, 2022
(86) PCT No.: PCT/JP2022/007704

§ 371 Date: Aug. 19, 2024

(51) Int. Cl. G01S 3/28; G01S 3/04

(52) U.S. Cl. CPC G01S 3/28; G01S 3/043

(57) ABSTRACT

A radio wave arrival direction estimation device according to one embodiment includes: a radio wave absorber extending vertically; a plurality of omnidirectional antennas arranged around the radio wave absorber so as to extend in the same direction as the radio wave absorber; a measuring unit configured to measure a received power or a C/N value of a radio wave received by the plurality of omnidirectional antennas; an estimation unit configured to estimate a radio wave arrival direction based on either of the received power or the C/N value measured by the measuring unit; and an output unit configured to output information indicating the radio wave arrival direction estimated by the estimation unit.

### TECHNICAL FIELD

The present invention relates to a radio wave arrival direction estimation device and a radio wave arrival direction estimation method.

### BACKGROUND ART

Several methods for estimating a direction-of-arrival of a radio wave in wireless communication have been proposed. For example, methods using a phase difference of a radio wave based on a difference in antenna positions and multiple signal classification (MUSIC) are promising; additionally, proposed is a method of enabling estimation of a direction-of-arrival of a radio wave on a horizontal plane by changing a direction of a main lobe or a null point of an antenna pattern (see, for example, Non Patent Literature 1).

In the related art, it is not assumed that a radio wave can arrive from any of three-directional directions, and a direction-of-arrival of the radio wave is estimated based on a correlation matrix obtained using an array antenna. That is, only planar arrival directions can be estimated.

### CITATION LIST

### Non Patent Literature

Non Patent Literature 1: Minseok Kim, “Torai hoko suitei system no kiso to jisso-rei (in Japanese) [Basics and Implementation of Direction-of-Arrival Estimation System]”, Design Wave Magazine, 2007 December, pp. 112-118.

### SUMMARY OF INVENTION

### Technical Problem

However, a plurality of antenna elements and an antenna with high directivity are required for the related art, and further, accuracy is not improved in a low frequency band.

A large antenna element and enlarged array antenna are required for a low frequency band such as the VHF band, so that it may be difficult to install the antenna element.

The present invention has been made to address the problems above, and an object thereof is to provide a radio wave arrival direction estimation device and a radio wave arrival direction estimation method, each capable of estimating a radio wave arrival direction with a simple configuration without using an antenna with high directivity.

### Solution to Problem

Provided is a radio wave arrival direction estimation device according to one embodiment of the present invention, the device including: a radio wave absorber extending vertically; a plurality of omnidirectional antennas arranged around the radio wave absorber so as to extend in the same direction as the radio wave absorber; a measuring unit configured to measure a received power or a C/N value of a radio wave received by the plurality of omnidirectional antennas; an estimation unit configured to estimate a radio wave arrival direction based on either of the received power or the C/N value measured by the measuring unit; and an output unit configured to output information indicating the radio wave arrival direction estimated by the estimation unit.

A radio wave arrival direction estimation method according to one embodiment of the present invention is a method for estimating a radio wave arrival direction using a radio wave absorber extending vertically and a plurality of omnidirectional antennas arranged around the radio wave absorber so as to extend in the same direction as the radio wave absorber, the method including:

a measuring step of measuring a received power or a C/N value of a radio wave received by the plurality of omnidirectional antennas;

an estimation step of estimating a radio wave arrival direction based on either of the received power or the C/N value measured; and

an output step of outputting information indicating the radio wave arrival direction estimated.

### Advantageous Effects of Invention

According to the present invention, it is possible to estimate a radio wave arrival direction with a simple configuration without using an antenna with high directivity.

### BRIEF DESCRIPTION OF DRAWINGS

FIG. 1 is a diagram illustrating a configuration example of a radio wave arrival direction estimation device according to one embodiment.

FIG. 2(a) is a diagram of an antenna unit as viewed from above. FIG. 2(b) is a perspective view of the antenna unit.

FIG. 3 is a diagram illustrating a radio wave arrival direction to the antenna unit.

FIG. 4 is a flowchart illustrating operations of the arrival direction estimation device.

FIG. 5 is a diagram illustrating a modified example of the antenna unit.

### DESCRIPTION OF EMBODIMENTS

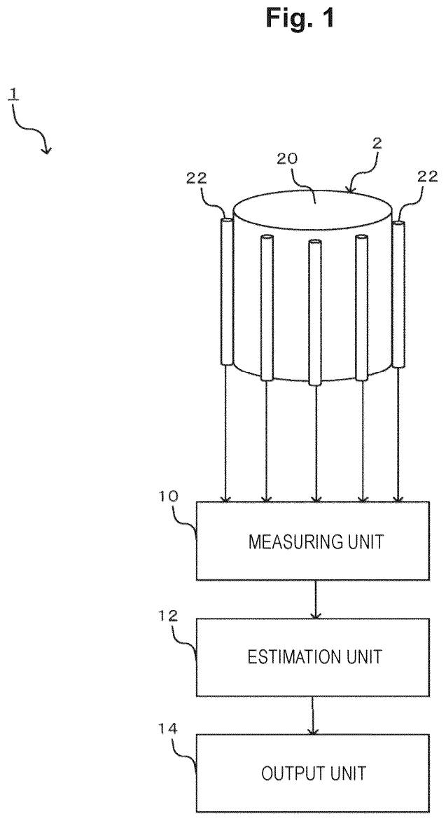

Hereinafter, a configuration example of a radio wave arrival direction estimation device 1 according to one embodiment will be described with reference to the drawings. FIG. 1 is a diagram illustrating a configuration example of the arrival direction estimation device 1 according to one embodiment.

As illustrated in FIG. 1, the arrival direction estimation device 1 according to one embodiment includes, for example, an antenna unit 2, a measuring unit 10, an estimation unit 12, and an output unit 14.

The antenna unit 2 includes a radio wave absorber 20 extending vertically and a plurality of omnidirectional antennas 22 arranged around the radio wave absorber 20 so as to extend in the same direction as the radio wave absorber 20, and outputs a received power of a radio wave received by the plurality of omnidirectional antennas 22 to the measuring unit 10. The omnidirectional antenna 22 is, for example, a whip antenna that is omnidirectional in the horizontal direction.

For example, the plurality of omnidirectional antennas 22 are arranged at equal intervals on a circumference centered on an axis extending vertically through the center of the radio wave absorber 20.

The measuring unit 10 measures a received power or a C/N value of the radio wave received by the plurality of omnidirectional antennas 22, and outputs the received power or the C/N value to the estimation unit 12.

The estimation unit 12 estimates an arrival direction of the radio wave on the basis of the received power or the C/N value measured by the measuring unit 10, and outputs information indicating the estimated arrival direction to the output unit 14.

The output unit 14 outputs the information indicating the radio wave arrival direction estimated by the estimation unit 12 by, for example, displaying the information.

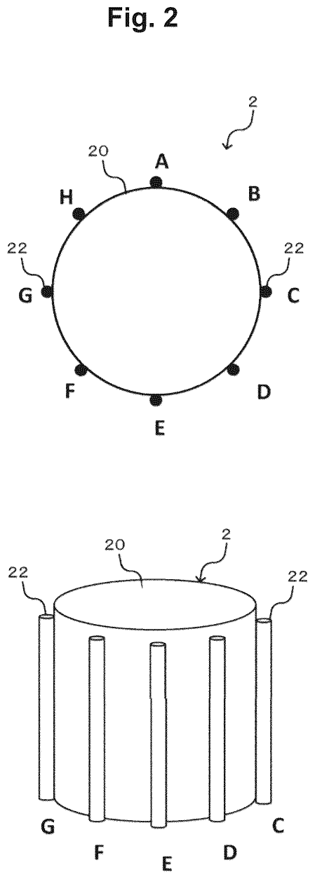

The antenna unit 2 will be described in more detail. FIG. 2 is a diagram illustrating a specific example of a configuration of the antenna unit 2. FIG. 2(a) is a diagram of the antenna unit 2 as viewed from above. FIG. 2(b) is a perspective view of the antenna unit 2.

As illustrated in FIG. 2, the plurality of omnidirectional antennas 22 are attached around the radio wave absorber 20 in the antenna unit 2. Here, eight omnidirectional antennas 22A to 22H are arranged at 45° intervals around the radio wave absorber 20. As the number of omnidirectional antennas 22 becomes larger, the higher the accuracy of estimation of the radio wave arrival direction by the arrival direction estimation device 1 is.

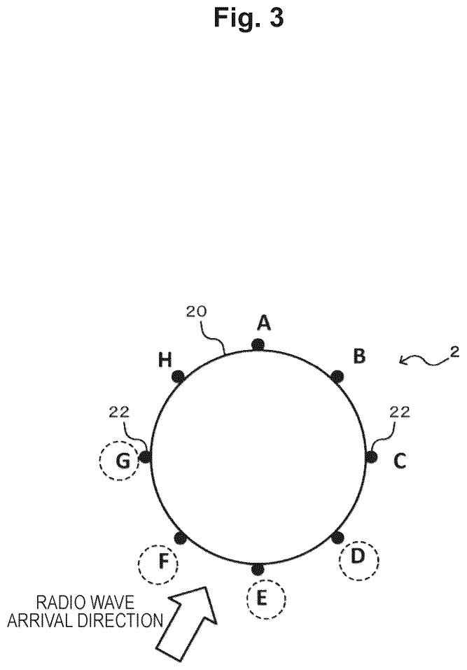

FIG. 3 is a diagram illustrating the radio wave arrival direction with respect to the antenna unit 2. As illustrated in FIG. 3, for example, it is assumed that radio waves arrive between the omnidirectional antennas 22F and 22E.

At this time, the omnidirectional antennas 22D, 22E, 22F, and 22G receive the radio waves at a high level. Therefore, the estimation unit 12 can estimate the radio wave arrival direction on the basis of a magnitude of the received power of the radio waves received by the omnidirectional antennas 22D, 22E, 22F, and 22G.

In a case where the radio wave arrives from the direction of the omnidirectional antenna 22F, the high level radio waves are received by the omnidirectional antennas 22D, 22E, 22F, 22G, and 22H with the largest received power at the omnidirectional antenna 22F. Therefore, the omnidirectional antenna 22 can estimate that the radio waves arrive from the direction of the omnidirectional antenna 22F.

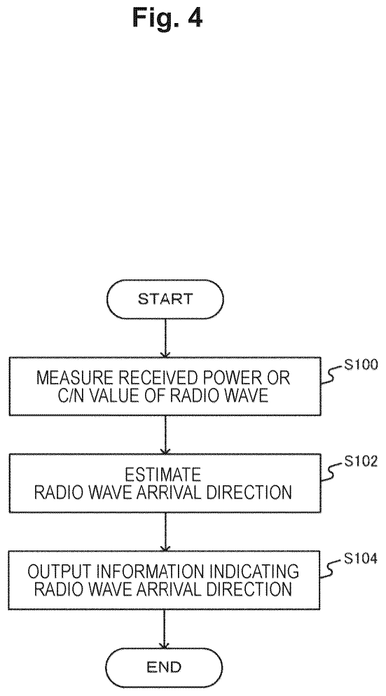

FIG. 4 is a flowchart illustrating operations of the arrival direction estimation device 1. As illustrated in FIG. 4, the measuring unit 10 in the arrival direction estimation device 1 measures the received power or the C/N value of the radio wave in step 100 (S100).

In step 102 (S102), the estimation unit 12 estimates the radio wave arrival direction.

In step 104 (S104), the output unit 14 displays and outputs information indicating the radio wave arrival direction.

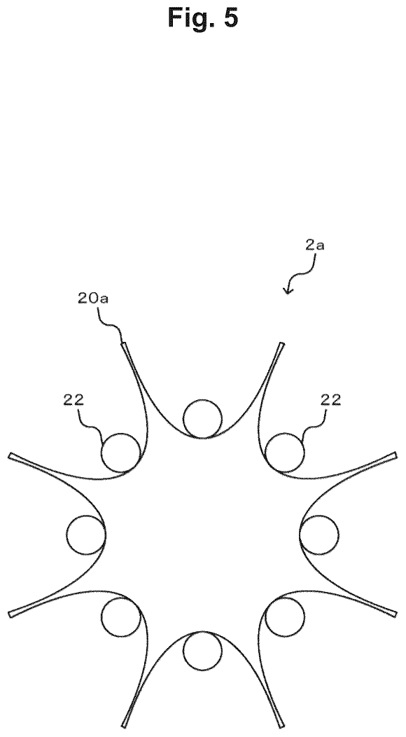

FIG. 5 is a diagram illustrating a modified example (antenna unit 2a) of the antenna unit 2. As illustrated in FIG. 5, a plurality of omnidirectional antennas 22 may be arranged at positions where side surfaces of a cylindrical radio wave absorber are recessed in the antenna unit 2a.

As described above, in the arrival direction estimation device 1, the antenna unit 2 includes the radio wave absorber 20 extending vertically and the plurality of omnidirectional antennas 22 arranged around the radio wave absorber 20 so as to extend in the same direction as the radio wave absorber 20. Therefore, the radio wave arrival direction can be estimated with a simple configuration but without an antenna having high directivity.

### REFERENCE SIGNS LIST

1 Arrival direction estimation device
2, 2a Antenna unit
10 Measuring unit
12 Estimation unit
14 Output unit
20, 20a Radio wave absorber
22 Omnidirectional antenna

1. A radio wave arrival direction estimation device, comprising:
a radio wave absorber extending vertically;
a plurality of omnidirectional antennas arranged around the radio wave absorber so as to extend in the same direction as the radio wave absorber;
measuring circuitry configured to measure a received power or a C/N value of a radio wave received by the plurality of omnidirectional antennas;
estimation circuitry configured to estimate a radio wave arrival direction based on either of the received power or the C/N value measured by the measuring circuitry; and
output circuitry configured to output information indicating the radio wave arrival direction estimated by the estimation circuitry.

2. The radio wave arrival direction estimation device according to claim 1,
wherein the plurality of omnidirectional antennas are arranged at equal intervals on a circumference centered on an axis extending vertically through the center of the radio wave absorber.

3. A radio wave arrival direction estimation method for estimating a radio wave arrival direction using a radio wave absorber extending vertically and a plurality of omnidirectional antennas arranged around the radio wave absorber so as to extend in the same direction as the radio wave absorber, the method comprising:
measuring a received power or a C/N value of a radio wave received by the plurality of omnidirectional antennas;
estimating a radio wave arrival direction based on either of the received power or the C/N value measured; and
outputting information indicating the radio wave arrival direction estimated.

4. The radio wave arrival direction estimation method according to claim 3, wherein the plurality of omnidirectional antennas are arranged at equal intervals on a circumference centered on an axis extending vertically through the center of the radio wave absorber.
